(19) United States
(12) Patent Application Publication
(10) Pub. No.: US 2021/0306740 A1
(43) Pub. Date: Sep. 30, 2021

(54) SPEAKER STRUCTURE AND SMART ROBOT

(71) Applicant: Coretronic Corporation, Hsin-Chu (TW)

(72) Inventor: Kun-Chen Hsu, Hsin-Chu (TW)

(73) Assignee: Coretronic Corporation, Hsin-Chu (TW)

(21) Appl. No.: 17/216,689

(22) Filed: Mar. 30, 2021

(30) Foreign Application Priority Data
Mar. 31, 2020 (CN) 202010241975.9

(51) Int. Cl. H04R 1/34; H04R 1/02; B25J 11/00; B62D 57/032; B25J 9/00

(52) U.S. Cl. CPC H04R 1/345; H04R 1/028; B25J 9/0006; B25J 11/0005; B62D 57/032; H04R 1/025

(57) ABSTRACT

A smart robot, including a speaker structure and a housing, is provided. The speaker structure is disposed in the housing and includes a plate, a speaker, and a conical acoustic reflector, assembled in the housing. The speaker structure includes a speaker grille, first and second stages extending into the housing. The speaker grille is disposed at the housing and between the first stage and second stages, and surrounds an axis. The plate is assembled to the first stage. The speaker is assembled to the plate. The conical acoustic reflector is disposed on the second stage. The conical acoustic reflector and the speaker are disposed along the axis and face each other. Each of the speaker and the conical acoustic reflector is symmetrical about the axis. A sound wave generated by the speaker is transmitted out of the housing from the speaker grille after being reflected via the conical acoustic reflector.

### CROSS-REFERENCE TO RELATED APPLICATION

This application claims the priority benefit of China application serial no. 202010241975.9, filed on Mar. 31, 2020. The entirety of the above-mentioned patent application is hereby incorporated by reference herein and made a part of this specification.

### BACKGROUND

### Technical Field

The disclosure relates to a speaker structure and a smart robot.

### Description of Related Art

With the manufacturing of smart equipment and development of R&D technology, a special type of smart robot currently emerges in daily life. The so-called smart robot is an intelligent equipment with diverse functions, which is equivalent to integrating different intelligent devices in a single intelligent equipment. For example, a smart robot may be integrated with an audio player having a speaker system and a video player having a projection system to achieve the voice dialogue function of the intelligent equipment and other various functions.

However, for a smart robot integrated with a speaker structure, there are limitations on the directionality of sound wave transmission, that is, the user and the smart robot are usually preset to be facing each other, so the conventional technology is to drive the sound wave of the speaker to be transmitted forward. When there are multiple users or when the user is behind the smart robot, the user(s) cannot clearly identify the sound emitted from the smart robot. Therefore, the broadcasting range of the smart robot is limited to the partial space in front of the smart robot, so the interaction between the user(s) and the smart robot is undeniably limited. As such, how to provide an omnidirectional structure of sound wave transmission to solve the above limitations and improve the effect of human-computer interaction is a subject to be considered and solved by persons skilled in the art.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a speaker structure and a smart robot, which enables the smart robot to provide an omnidirectional transmission of sound wave.

Other objectives and advantages of the invention may be further understood from the technical features disclosed in the disclosure.

In order to achieve one, part, or all of the above objectives or other objectives, an embodiment of the disclosure provides a speaker structure, configured to be disposed in a housing. The speaker structure includes a plate, a speaker, and a conical acoustic reflector. The plate, the speaker, and the conical acoustic reflector are assembled in the housing. The speaker structure includes a speaker grille, a first stage and a second stage, wherein the first stage and the second stage extend toward an interior of the housing. The speaker grille is disposed at the housing and is formed by a plurality of openings. The speaker grille surrounds an axis and is located between the first stage and the second stage. The plate is assembled to the first stage, the speaker is assembled to the plate, and the conical acoustic reflector is disposed on the second stage. The conical acoustic reflector and the speaker are disposed along the axis and face each other. Each of the speaker and the conical acoustic reflector is symmetrical about the axis. A sound wave generated by the speaker is transmitted out of the housing from the speaker holes after being reflected via the conical acoustic reflector.

In order to achieve one, part, or all of the above objectives or other objectives, an embodiment of the disclosure provides a smart robot, including a speaker structure and a housing. The speaker structure is disposed in the housing and includes a plate, a speaker, and a conical acoustic reflector. The plate, the speaker, and the conical acoustic reflector are assembled in the housing. The speaker structure includes a speaker grille, a first stage and a second stage, wherein the first stage and the second stage extend toward an interior of the housing. The speaker grille is disposed at the housing and is formed by a plurality of openings. The speaker grille surrounds an axis and is located between the first stage and the second stage. The plate is assembled to the first stage, the speaker is assembled to the plate, and the conical acoustic reflector is disposed on the second stage. The conical acoustic reflector and the speaker are disposed along the axis and face each other. Each of the speaker and the conical acoustic reflector is symmetrical about the axis. A sound wave generated by the speaker is transmitted out of the housing from the speaker holes after being reflected via the conical acoustic reflector.

Based on the above, the speaker structure is to respectively dispose the plate and the conical acoustic reflector on the first stage and the second stage in the housing, and dispose the speaker on the plate. Also, the speaker and the conical acoustic reflector are coaxial and face each other. As such, the sound wave generated by the speaker may be transmitted out of the housing from the speaker grille disposed to surround the axis after being reflected via the conical acoustic reflector, thereby achieving an omnidirectional effect of sound wave transmission.

Furthermore, the conical acoustic reflector is symmetrical relative to the axis, in other words, the conical acoustic reflector is an axisymmetric cone and the vertex thereof is located on the axis. Therefore, the cone and the speaker grille, which are also disposed to surround the axis, may correspond to each other, thereby smoothly reflecting the sound wave from the speaker to be transmitted out of the housing via the speaker grille, such that the unidirectional sound wave (transmitted from the speaker) may be smoothly formed into an omnidirectional sound wave. As such, the smart robot applied with the speaker structure can smoothly generate whole region sound waves and the user can clearly hear the sound transmitted by the speaker regardless of the orientation of the user relative to the smart robot.

Other objectives, features and advantages of the disclosure will be further understood from the further technological features disclosed by the embodiments of the disclosure wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a smart robot according to an embodiment of the disclosure.

FIG. 2 is a schematic view of a portion of the smart robot of FIG. 1.

FIG. 3 is an exploded view of some components of the smart robot of FIG. 1.

FIG. 4 is a cross-sectional view of a portion of the smart robot of FIG. 1.

FIG. 5 shows a frequency response diagram of whether a speaker structure is equipped with an acoustically transparent fabric.

FIG. 6 and FIG. 7 show frequency response diagrams of speaker grille of a speaker structure with different aperture ratios.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

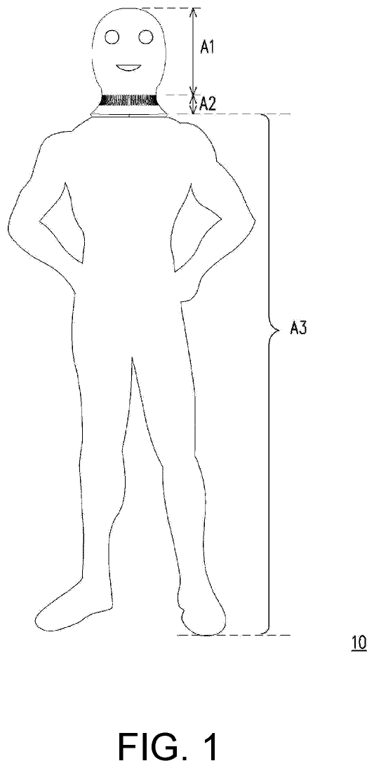

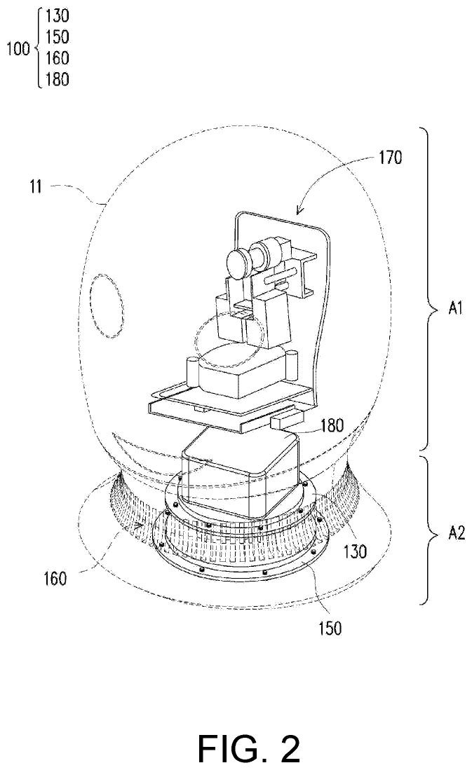

FIG. 1 is a schematic view of a smart robot according to an embodiment of the disclosure. FIG. 2 is a schematic view of a portion of the smart robot of FIG. 1. Please refer to FIG. 1 and FIG. 2 at the same time. In the embodiment, a smart robot 10 includes a head A1, a neck A2, and a body A3 (including torso and four limbs), wherein the head A1 and the neck A2 forms a hollow housing 11 and the torso of the body A3 may be a hollow or solid structure according to actual design requirements, and the disclosure is not limited thereto. A speaker structure 100 is configured to dispose inside the housing 11. Here, the speaker structure 100 provides a sound transmission function in order to be able to interact with the user. Different components will be described one by one in the following.

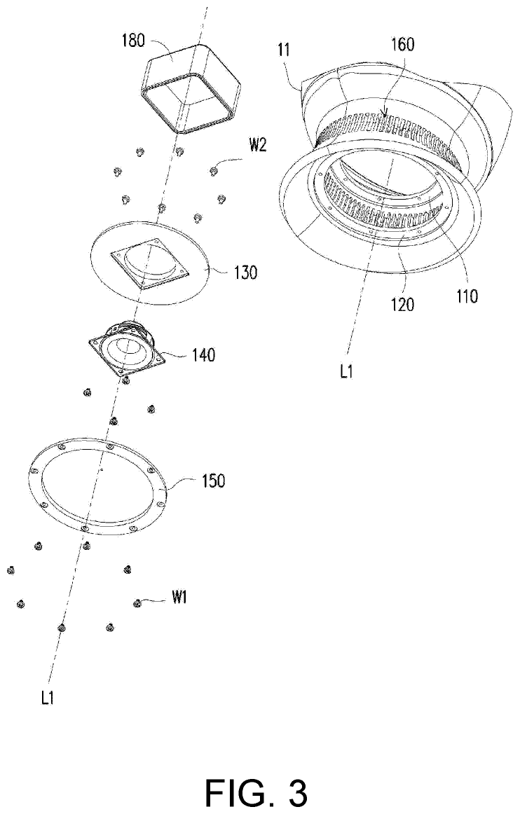

FIG. 3 is an exploded view of some components of the smart robot of FIG. 1. Please refer to FIG. 2 and FIG. 3 at the same time. The speaker structure 100 disposed in the housing 11 includes a plate 130, a speaker 140, and a conical acoustic reflector 150 assembled in the housing 11. Furthermore, the speaker structure 100 further includes a speaker grille 160, a first stage 110 and a second stage 120 disposed at the housing 11. The first stage 110 and the second stage 120 extend from the housing 11 toward an interior of the housing 11, wherein the housing 11 contains a plurality of openings 161 to form the speaker grille 160. The openings 161 are disposed at the neck A2 of the housing 11 surrounding an axis L1 and are located between the first stage 110 and the second stage 120. Here, the plate 130 is assembled onto the first stage 110, the speaker 140 is assembled onto the plate 130, and the conical acoustic reflector 150 is assembled onto the second stage 120, wherein the conical acoustic reflector 150 and the speaker 140 are arranged along the axis L1 and face each other. Each of the speaker 140 and the conical acoustic reflector 150 is symmetrical about the axis L1, such that the sound wave generated by the speaker 140 is transmitted out of the housing 11 from the speaker grille 160 after being reflected by the conical acoustic reflector 150.

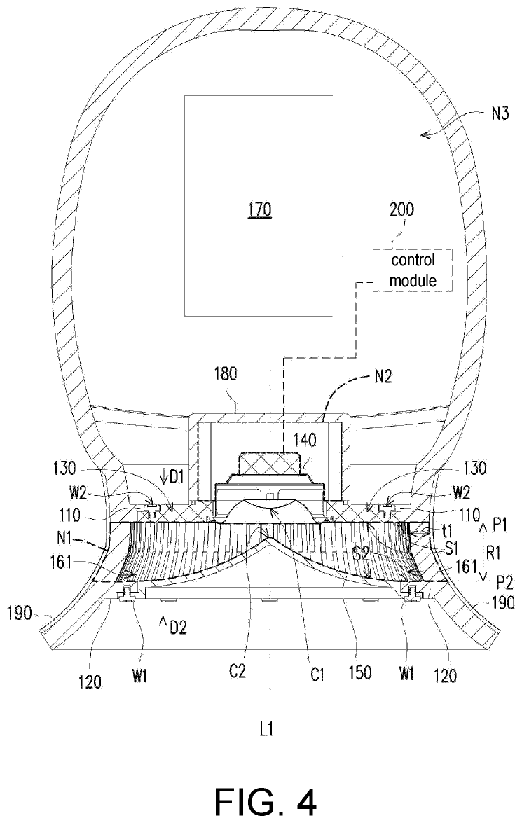

FIG. 4 is a cross-sectional view of a portion of the smart robot of FIG. 1. Please refer to FIG. 3 and FIG. 4 at the same time. In detail, the first stage 110 and the second stage 120 are disposed on the inner wall of the housing 11, and the first stage 110 and the second stage 120 extend from the inner wall toward the interior of the housing 11, which may be manufactured by measures such as assembly using a component or integral molding. As shown in FIG. 4, the direction in which the speaker 140 is assembled to the plate 130 positioned on the first stage 110 is the same as a direction D2 in which the conical acoustic reflector 150 is assembled to the second stage 120, and a direction D1 in which the plate 130 is assembled to the first stage 110 and the direction D2 in which the conical acoustic reflector 150 is assembled to the second stage 120 are opposite to each other, wherein the first stage 110 and the plate 130 form a plane S1, the second stage 120 and a conical reflection surface of the conical acoustic reflector 150 form a smooth surface S2, and the plane S1 and the smooth surface S2 face each other. In the embodiment, the speaker 140 is fixed to the plate 130, the plate 130 is substantially locked to the first stage 110 through at least one screw W2, and the conical acoustic reflector 150 is locked to the second stage 120 through at least one screw W1. The screw W2 used to lock the plate 130 is not located on the plane S1, and the screw W1 used to lock the conical acoustic reflector 150 is not located on the smooth surface S2. As such, the first stage 110, the second stage 120, the plate 130, the speaker 140, and the conical acoustic reflector 150 together with a portion of the housing 11 may form a first sound chamber N1 of the speaker 140 in the housing 11 and the openings 161 disposed at the housing 11 are disposed to surround the first sound chamber N1. In other embodiments, the plate 130 used to fix the speaker 140 may be fixed to the first stage 110 through an adhesive or a tenon structure. The conical acoustic reflector 150 may be fixed to the second stage 120 through an adhesive or a tenon structure, and the disclosure does not limit the fixing method. In addition, in other embodiments, the screw W2 used to lock the plate 130 may be located on the plane S1 and the screw W1 used to lock the conical acoustic reflector 150 may be located on the smooth surface S2, which are not limited in the disclosure.

Furthermore, the housing 11 has an annular region R1. In the embodiment, the annular region R1 is located at the neck A2 of the housing 11. The annular region R1 surrounds the first stage 110, the second stage 120, the speaker 140, the plate 130, and the conical acoustic reflector 150. The speaker grille 160 is located at the annular region R1 and the orthographic projection range of each opening 161 on the axis L1 is aligned with the first stage 110 and the second stage 120. In other words, as shown in FIG. 4, as a constituent structure of the first sound chamber N1, the orthographic projections of the plane S1 and the smooth surface S2 on the axis L1 have references P1 and P2, wherein the first stage 110 corresponds to the reference P1, the second stage 120 corresponds to the reference P2, and the annular region R1 is located between the references P1 and P2. More importantly, the openings 160 being aligned with the first stage 110 and the second stage 120 are also equivalent to being aligned with the references P1 and P2. As such, the range of the openings 160 along the axis L1 may be corresponding to and consistent with reflection range of the sound wave reflected by the conical acoustic reflector 150 to ensure that all sound waves reflected by the conical acoustic reflector 150 may be transmitted out of the housing 11 via the speaker grille 160 without leakage.

On the other hand, if the orthographic projection range of each opening 161 along the axis L1 is lower than the references P1 and P2, phase interference of the sound waves may easily happen. In addition, as shown in FIG. 2 to FIG. 4, the speaker structure 100 further includes a cover 180, configured to be assembled to the plate 130 and to enclose the speaker 140. If the speaker structure 100 does not use the cover 180, there would be leakage of sound wave when the orthographic projection range of the openings 161 along the axis L1 exceeds the reference P1. In addition, the screws W1 and W2 lock the conical acoustic reflector 150 and the plate 130 in opposite directions to ensure that the plane S1 and the smooth surface S2 have no additional structural interference, which is more conducive to the transmission of sound wave in the first sound chamber N1 to prevent attenuation. At the same time, the first sound chamber N1 only communicates with the external environment through the speaker grille 160, which may effectively prevent foreign objects from entering the first sound chamber N1 to interfere with the sound wave transmitted therein while also providing a protective effect to the diaphragm component of the speaker 140.

Based on the above, the conical acoustic reflector 150 is a symmetrical conical disc relative to the axis L1. A vertex C2 of the conical acoustic reflector 150 is located on the axis L1 while a diaphragm center C1 of the speaker 140 is also located on the axis L1 and corresponds to the vertex C2, which may corresponds to the openings 161 also surrounding the axis L1, thereby smoothly reflecting the sound wave transmitted from the speaker 140 through the conical reflection surface of the conical acoustic reflector 150 to be transmitted out of the housing 11 via the speaker grille 160, that is, the distribution range of the speaker grille 160 includes the sound wave transmitted out of the housing 11 from the first sound chamber N1. In this way, the unidirectional sound wave generated from the speaker 140 and transmitted toward the conical acoustic reflector 150 may be smoothly formed into an omnidirectional sound wave. The reflected sound wave is transmitted out of the housing 11 in a 360-degree radial pattern toward the surrounding (for example, the periphery of the plane with the axis L1 as the normal) with the axis L1 as the center. In the embodiment, the materials of the conical acoustic reflector 150 and the plate 130 are not limited, which may be plastic material, metal material, ceramic material, glass material, and wood material. A material with a smoother surface and a lower sound absorption coefficient provides a better reflective effect.

On the other hand, please refer to FIG. 2 and FIG. 4 again. The smart robot 10 of the embodiment further includes a projection module 170 and a control module 200, wherein the projection module 170 and the control module 200 are disposed in the housing 11. The control module 200 is electrically connected to the projection module 170 and the speaker 140, so as to drive the projection module 170 and the speaker 140. The projection module 170 and the conical acoustic reflector 150 are located on two opposite sides of the plate 130. Further, as shown in FIG. 1, FIG. 2, and FIG. 4, the projection module 170 is, for example, disposed in the head A1 of the smart robot 10. The smart robot 10 with the projection module 170 and the speaker structure 100, which may further provide the interactive effect required by the user in addition to having the image projection function. In the embodiment, the cover 180 is sealed to the plate 130 and encloses the speaker 140 to form a second sound chamber N2 of the speaker 140. Furthermore, the cover 180 also forms a space N3 with a portion of the housing 11 while forming the second sound chamber N2. The projection module 170 is not located in the second sound chamber N2 but is located in the space N3. In this way, the cover 180 may effectively separate the second sound chamber N2 and the space N3 to prevent the sound wave of the speaker 140 from being transmitted to the space N3 and affecting the projection module 170. At the same time, the second sound chamber N2 formed by the cover 180 has a specific shape, that is, the user may select the corresponding cover 180 according to the spectral characteristics of the speaker 140, so as to prevent the appearance, size, or material of the housing 11 from affecting the sound wave spectrum of the speaker 140 if the cover 180 is not used.

Here, the first sound chamber N1 and the second sound chamber N2 are respectively located at two opposite sides of the plate 130 and the first stage 110. The first sound chamber N1 and the second sound chamber N2 are separated from each other without communication by the plate 130 and the first stage 110, which may effectively prevent the sound wave of the second sound chamber N2 from being transmitted to the first sound chamber N1. In addition, if the cover 180 is not used, the plate 130 and the first stage 110 form the space N3 with a portion of the housing 11. The first sound chamber N1 and the space N3 are respectively located at two opposite sides of the plate 130 and the first stage 110. The first sound chamber N1 and the space N3 are separated from each other without communication by the plate 130 and the first stage 110, so as to prevent the sound wave of the speaker 140 from being transmitted to the space N3 and affecting the projection module 170.

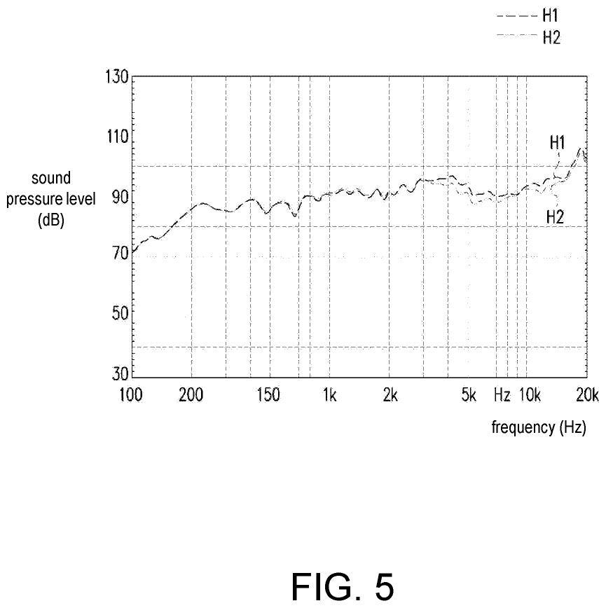

The speaker structure 100 of the embodiment further includes an acoustically transparent fabric 190, disposed outside the housing 11 and covering the speaker grille 160. Here, taking the acoustically transparent fabric 190 being disposed at the neck A2 of the smart robot 10 as an example, the acoustically transparent fabric 190 is configured to decorate the appearance of the smart robot 10, such that the user may not easily see the structure of the speaker grille 160 and the structure inside the housing 11 while also providing a dustproof effect. FIG. 5 shows a frequency response diagram of whether a speaker structure is equipped with an acoustically transparent fabric, which is configured to show the corresponding relationship between the frequency and the sound pressure level (SPL) of the sound wave. Please refer to FIG. 5, wherein a curve H1 represents the frequency response state without disposing the acoustically transparent fabric 190 and a curve H2 represents the frequency response state with the acoustically transparent fabric 190 disposed. As shown in FIG. 5, although the acoustically transparent fabric 190 slightly attenuates the high-frequency sound wave, the degree of attenuation is actually less than 3 dB. Therefore, there is no significant difference to the hearing of the user. At the same time, the acoustically transparent fabric 190 has the effect of modifying the timbre. Different materials of acoustically transparent fabrics may be used according to the type of speaker, which generate different degrees of attenuation of high-frequency sound wave.

It should also be mentioned that the appearance of the speaker grille 160 of the disclosure is not limited. The speaker grille 160 is formed by the fence openings 161 in FIG. 2 to FIG. 4. In other embodiments not shown, the speaker grille 160 may also be formed by hexagon holes, square holes, elliptical holes, or round holes. In addition, please refer to FIG. 4. In the embodiment, for the speaker structure 100, in addition to the aperture range of the speaker grille 160 mentioned above, the material of the housing 11, a thickness t1 of the housing 11 at the annular region R1, and the aperture ratio of the speaker grille 160 at the annular region R1 will also affect the sound wave transmitted. Here, the aperture ratio is substantially equal to the total aperture area of the openings divided by the surface area of the annular region R1, that is, aperture ratio=(total aperture area of openings)/(surface area of annular region)×100%.

For example, the housing 11 is made of a metal material with a thickness of 1 mm at the annular region R1 and the aperture ratio of the speaker grille 160 at the annular region R1 is at least greater than 15% to ensure the sound quality transmitted out of the housing 11. In addition, for example, the housing 11 is made of a plastic material with a thickness of 2 mm at the annular region R1 and the aperture ratio of the speaker grille 160 at the annular region R1 is at least greater than 20%, such that the sound transmitted out of the housing 11 may have a more ideal effect.

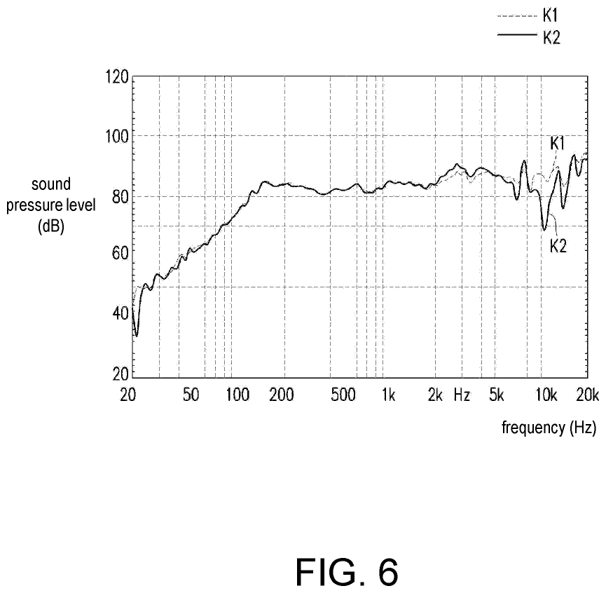

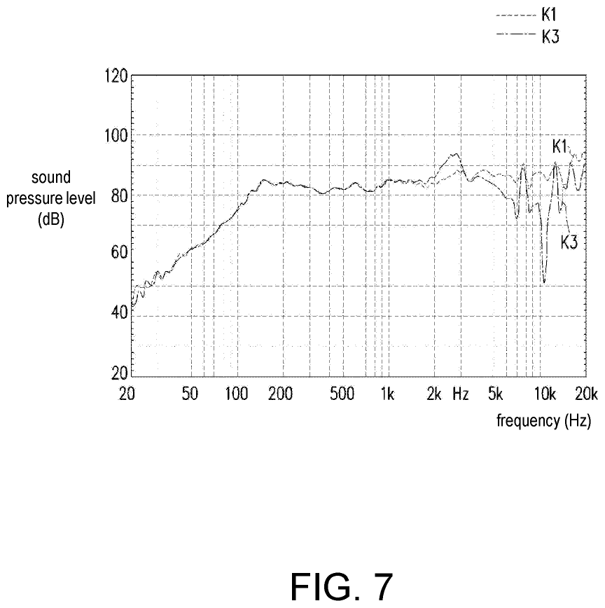

FIG. 6 and FIG. 7 show frequency response diagrams of speaker grille of a speaker structure with different aperture ratios. Please refer to FIG. 6 and FIG. 7 at the same time. The speaker grille 160 with different aperture ratios is disposed using a plastic material (for example, ABS) with a thickness of 2 mm. A curve K1 represents that the aperture ratio of the speaker grille 160 is 100%, which is equivalent to a completely open space. A curve K2 represents that the aperture ratio of the speaker grille 160 is 20%. A curve K3 represents that the aperture ratio of the speaker grille 160 is 10%. As shown in FIG. 6, the high-frequency sound wave will be attenuated due to the influence of the aperture grille with the aperture ratio of 20%, but the frequency range with a more severe attenuation is still within ⅓ octave band and the rest of the frequencies are not significantly attenuated. Therefore, the sound wave transmitted out of the housing 11 is still within an acceptance hearing range of the user. Next, please refer to FIG. 7, both the degree of attenuation and the bandwidth affected of the sound wave shown are greater than as shown in FIG. 6, so the hearing effect of the user is seriously affected.

In summary, in the above embodiments of the disclosure, the speaker structure is to respectively dispose the plate and the conical acoustic reflector on the first stage and the second stage in the housing, and dispose the speaker on the plate. Also, the speaker and the conical acoustic reflector are coaxial and face each other. As such, the sound wave generated by the speaker may be transmitted out of the housing from the speaker grille surrounding the axis after being reflected via the conical acoustic reflector, thereby achieving an omnidirectional effect of sound wave transmission. In more detail, although the above embodiments of the disclosure only show the cover, the speaker, the plate, and the conical acoustic reflector being sequentially disposed from the head of the housing toward the neck in the speaker structure, in other embodiments, for example, the conical acoustic reflector, the plate, the speaker, and the cover may also be sequentially disposed from the head of the housing toward the neck in the speaker structure, and the disclosure is not limited thereto.

Further, the conical acoustic reflector is a symmetrical conical disc relative to the axis, the vertex thereof is located on the axis, and the diaphragm center of the speaker is also located on the axis and corresponds to the vertex, which may correspond to the speaker grille surrounding the axis, thereby smoothly forming the unidirectional sound wave transmitted from the speaker toward the conical acoustic reflector into an omnidirectional sound wave. Also, the reflected sound wave is transmitted out of the housing in a 360-degree radial pattern toward the surrounding (for example, the plane with the axis as the normal) with the axis as the center.

In this way, regardless of the orientation of the user relative to the smart robot, the sound transmitted by the speaker structure may be clearly heard, such that the speaker structure is no longer limited by the directionality of sound and the interaction range with the user.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the disclosure” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the disclosure as defined by the following claims. Moreover, no element and component in the present disclosure is intended to be dedicated to the public regardless of whether the element or component is explicitly recited in the following claims.

What is claimed is:

1. A speaker structure, disposed in a housing, comprising: a plate, a speaker, and a conical acoustic reflector, wherein the plate, the speaker, and the conical acoustic reflector are assembled in the housing; wherein
the speaker structure comprises a speaker grille, a first stage and a second stage, wherein the first stage and the second stage extend toward an interior of the housing and the speaker grille is disposed at the housing and is formed by a plurality of openings surrounding an axis, and the speaker grille is located between the first stage the second stage;
the plate is assembled to the first stage;
the speaker is assembled to the plate; and
the conical acoustic reflector is disposed on the second stage, wherein the conical acoustic reflector and the speaker are disposed along the axis and face each other, each of the speaker and the conical acoustic reflector is symmetrical about the axis, and a sound wave generated by the speaker is transmitted out of the housing from the speaker grille after being reflected via the conical acoustic reflector.

2. The speaker structure according to claim 1, wherein the first stage, the second stage, the plate, the speaker, and the conical acoustic reflector form a first sound chamber of the speaker in the housing and the plurality of opening is disposed to surround the first sound chamber.

3. The speaker structure according to claim 1, wherein the first stage and the plate form a plane, and the plane faces the conical acoustic reflector and the second stage.

4. The speaker structure according to claim 1, wherein the second stage and a conical reflection surface of the conical acoustic reflector form a smooth surface and the smooth surface faces the plate and the first stage.

5. The speaker structure according to claim 1, wherein a direction in which the plate is assembled to the first stage and a direction in which the conical acoustic reflector is assembled to the second stage are opposite to each other, the first stage and the plate form a plane, the second stage and a conical reflection surface of the conical acoustic reflector form a smooth surface, and the plane and the smooth surface face each other.

6. The speaker structure according to claim 5, wherein the plate is locked to the first stage through at least one screw, the conical acoustic reflector is locked to the second stage through at least one screw, the at least one screw used to lock the plate is not located on the plane, and the at least one screw used to lock the conical acoustic reflector is not located on the smooth surface.

7. The speaker structure according to claim 1, wherein the housing has an annular region surrounding the first stage, the second stage, the speaker, the plate, and the conical acoustic reflector, the speaker grille is located at the annular region, and an orthographic projection range of each of the plurality of openings on the axis is aligned with the first stage and the second stage.

8. The speaker structure according to claim 7, wherein the annular region is made of a metal material with a thickness of 1 mm and an aperture ratio of the speaker grille at the annular region is at least greater than 15%.

9. The speaker structure according to claim 7, wherein the annular region is made of a plastic material with a thickness of 2 mm and an aperture ratio of the speaker grille at the annular region is at least greater than 20%.

10. The speaker structure according to claim 1, wherein the speaker structure further comprises an acoustically transparent fabric, disposed outside the housing and covering the speaker grille.

11. The speaker structure according to claim 1, wherein the speaker structure further comprises a cover,
the cover is sealed to the plate and encloses the speaker to form a second sound chamber of the speaker, wherein a projection module and the conical acoustic reflector disposed in the housing are located at opposite sides of the plate and the projection module is located outside the second sound chamber.

12. A smart robot, comprising: a speaker structure and a housing, wherein the speaker structure is disposed in the housing and comprises a plate, a speaker, and a conical acoustic reflector, and the plate, the speaker, and the conical acoustic reflector are assembled in the housing; wherein
the speaker structure comprises a speaker grille, a first stage and a second stage, the first stage and the second stage extend toward an interior of the housing, and the speaker grille is disposed at the housing and is formed by a plurality of openings surrounding an axis, the plate is assembled to the first stage, the speaker is assembled to the plate, and the conical acoustic reflector is disposed on the second stage, wherein the conical acoustic reflector and the speaker are disposed along the axis and face each other, each of the speaker and the conical acoustic reflector is symmetrical about the axis, and a sound wave generated by the speaker is transmitted out of the housing from the speaker grille after being reflected via the conical acoustic reflector.

13. The smart robot according to claim 12, wherein the speaker, the plate, the conical acoustic reflector, and a portion of the housing form a first sound chamber and the plurality of openings is disposed to surround the first sound chamber.

14. The smart robot according to claim 12, wherein the housing is a head and a neck of the smart robot and the speaker grille is located at the neck of the smart robot.

15. The smart robot according to claim 12, wherein the first stage and the plate form a plane, and the plane faces the conical acoustic reflector and the second stage.

16. The smart robot according to claim 12, wherein the second stage and a conical reflection surface of the conical acoustic reflector form a smooth surface, and the smooth surface faces the plate and the first stage.

17. The smart robot according to claim 12, wherein a direction in which the plate is assembled to the first stage and a direction in which the conical acoustic reflector is assembled to the second stage are opposite to each other, the first stage and the plate form a plane, the second stage and a conical reflection surface of the conical acoustic reflector form a smooth surface, and the plane and the smooth surface face each other.

18. The smart robot according to claim 17, wherein the plate is locked to the first stage through at least one screw, the conical acoustic reflector is locked to the second stage through at least one screw, the at least one screw used to lock the plate is not located on the plane, and the at least one screw used to lock the conical acoustic reflector is not located on the smooth surface.

19. The smart robot according to claim 12, wherein the housing has an annular region surrounding the first stage, the second stage, the speaker, the plate, and the conical acoustic reflector, the speaker grille is located at the annular region, and an orthographic projection range of each of the plurality of openings on the axis is aligned with the first stage and the second stage.

20. The smart robot according to claim 19, wherein the annular region is made of a metal material with a thickness of 1 mm and an aperture ratio of the speaker grille at the annular region is at least greater than 15%.

21. The smart robot according to claim 19, wherein the annular region is made of a plastic material with a thickness of 2 mm and an aperture ratio of the speaker grille at the annular region is at least greater than 20%.

22. The smart robot according to claim 12, wherein the smart robot further comprises an acoustically transparent fabric, disposed outside the housing and covering the speaker grille.

23. The smart robot according to claim 12, wherein the smart robot further comprises a projection module and a cover, wherein,
the projection module is disposed in the housing and the projection module and the conical acoustic reflector are located at opposite sides of the plate; and
the cover is sealed to the plate and encloses the speaker to form a second sound chamber of the speaker.
